(19) United States
(12) Patent Application Publication
(10) Pub. No.: US 2011/0298786 A1
(43) Pub. Date: Dec. 8, 2011

(54) Color electronic paper display device and method for manufacturing the same

(75) Inventors: Jae Choon Cho, Suwon-si (KR); Sang Moon Lee, Seoul (KR); Hyung Mi Jung, Suwon-si (KR); Choon Keun Lee, Suwon-si (KR)

(73) Assignee: SAMSUNG ELECTRO-MECHANICS CO., LTD., Suwon (KR)

(21) Appl. No.: 12/923,456

(22) Filed: Sep. 22, 2010

(30) Foreign Application Priority Data
Jun. 7, 2010 (KR) 10-2010-0053430

(51) Int. Cl. G06F 3/038; G09G 3/34

(52) U.S. Cl. 345/214; 345/84

(57) ABSTRACT

The present invention provides a color electronic paper display device including: rotating balls; a barrier structure for partitioning the rotating balls; and an electrode structure which is provided in the barrier structure and applies voltages to the rotating balls, wherein the barrier structure is made of a photo-reactive barrier material including insulating resin, hardener, and a photo-sensitive material.

### CROSS-REFERENCE TO RELATED APPLICATIONS

This application claims the benefit of Korean Patent Application No. 10-2010-0053430 filed with the Korea Intellectual Property Office on Jun. 7, 2010, the disclosure of which is incorporated herein by reference.

### BACKGROUND OF THE INVENTION

1. Field of the Invention

The present invention relates to a color electronic paper display device and method for manufacturing the same; and, more particularly, to a color electronic paper display device to implement high color clarities and contrast ratios and a method for manufacturing the same.

2. Description of the Related Art

Of next-generation display devices, a color electronic paper display device has availability and flexibility higher than those of other display devices and driving force, and is characterized by a low driving power. Thus, the color electronic paper display device may be used instead of a paper print media like a book, and may be applicable to related fields, such as electronic wallpapers and screens of various types,

As a representative color electronic paper display device, a color electronic paper display device has been used which has rotating balls constituted by hemispheres with different colors from each other. The color electronic paper display device of the twist ball type includes a plurality of rotating balls, a barrier structure for partitioning the rotating balls, an electrode structure for rotating the rotating balls, and a transparent insulating oil for giving lubricity to the rotating balls.

There has recently been a trend toward a need to improve color clarity and contrast ratio of the color electronic paper display device. To this end, the number of the rotating balls should be increased for each of unit-areas. For an increase in the unit-areas, it is necessary to reduce intervals between cavities where the rotating balls are positioned in the barrier structure. At present, a widely-used method for forming the barrier structure includes an imprint method, a sandblast method, a laser processing method, and so on. The imprint method is based on the fact that after formation of a resin layer on a substrate, partition spaces are formed for disposition of the rotating balls on the resin layer through a stamp. However, there is a limit to a reduction in intervals between the partition spaces by the imprint process. For example, in case where side walls to partition the rotating balls are formed to be thin by the imprint process, due to the pressure of the stamp or other process factors, there occurs damage of the side walls. Therefore, reduction of the side walls by the stamp-based barrier formation technology has a limitation. In more particular, it is very difficult for the conventional stamp-based barrier formation technology to reduce thickness of the side wall to 20 μm or lower. Also, other methods, such as a sandblast method and a laser processing method, have also limitation to reduce thicknesses of side walls on the barrier structure. In particular, the above-mentioned methods have difficulties to form the side walls to have a vertical structure, and thus the thicknesses become larger.

### SUMMARY OF THE INVENTION

The present invention has been proposed in order to overcome the above-described problems and it is, therefore, an object of the present invention to provide a color electronic paper display device which has a structure to implement high color clarity and contrast ratio.

Further, another object of the present invention is to provide a color electronic paper display device which has a structure to increase rotating balls for each of unit-areas.

Further, another object of the present invention is to provide a color electronic paper display device for implementing high color clarity and contrast ratio.

Further, another object of the present invention is to provide a color electronic paper display device for increasing rotating balls for each of unit-areas.

In accordance with one aspect of the present invention to achieve the object, there is provided a color electronic paper display device including: rotating balls; a barrier structure for partitioning the rotating balls; and an electrode structure which is provided in the barrier structure and applies voltages to the rotating balls, wherein the barrier structure is made of a photo-reactive barrier material including insulating resin, hardener, and a photo-sensitive material.

Also, the insulating resin includes at least one of naphthalene epoxy resin and rubber modified epoxy resin.

Also, the hardener includes at least one of phenol novolac and bisphenol novolac.

Also, the photo-sensitive material includes a photo-sensitive monomer and photo-initiator, the photo-sensitive monomer including acrylate resin.

Also, the photo-reactive barrier material further includes inorganic filler, the inorganic filler including at least one of graphite, carbon black, silica, and clay.

Also, the barrier structure includes side walls for partitioning each of the rotating balls, the side walls defining cavities with cylinder shapes.

Also, the barrier structure includes side walls for partitioning each of the rotating balls, the side walls defining the cavities whose upper and lower diameters are the same.

Also, the barrier structure includes side walls for partitioning each of the rotating balls, the side walls having side surfaces with an up and down vertical structure.

Also, the barrier structure includes side walls for partitioning each of the rotating balls, the side walls having thicknesses of 20 μm or lower.

Also, the barrier structure is formed through a photolithography process.

In accordance with another aspect of the present invention to achieve the object, there is provided a method for manufacturing a color electronic paper display device including the steps of: preparing a photo-reactive barrier material which includes an insulating resin, hardener, and a photo-sensitive material; forming a barrier structure for defining cavities of cylinder shapes, on a base substrate; positioning rotating balls within the cavities; and forming an electrode structure which applies voltages to the rotating balls on the barrier structure.

Also, at least one of naphthalene epoxy resin and rubber modified epoxy resin is used as the insulating resin.

Also, at least one of phenol novolac and bisphenol novolac is used as the hardener.

Also, the photo-sensitive material includes a photo-sensitive monomer and a photo-initiator, the photo-sensitive monomer including acrylate resin.

Also, the step of forming the barrier structure further includes a step of curing the photo-reactive barrier material.

Also, the step of forming the barrier structure includes the steps of: forming the photo-reactive barrier material on the base substrate at a uniform thickness; and performing a photolithography process for the photo-reactive barrier material.

Also, the step of performing the photolithography process includes the steps of: positioning a mask for light-shielding desired regions where the cavities of the photo-reactive barrier material are to be formed; scanning light on the photo-reactive barrier material through the mask; and performing a developing process for removing non light-receiving areas of the photo-reactive barrier material.

Also, the step of performing the developing process includes the steps of: supplying a developing solution containing Na₂CO3 to the photo-reactive barrier material; and supplying an organic solvent to dissolve the insulating resin of the photo-reactive barrier material.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a color electronic paper display device in accordance with an embodiment of the present invention;

FIG. 2 is a flowchart showing a method for manufacturing a color electronic paper display device in accordance with an embodiment of the present invention; and

FIGS. 4 to 7 are views showing processes of manufacturing a color electronic paper display device in accordance with an embodiment of the present invention, respectively.

### DETAILED DESCRIPTION OF THE PREFERABLE EMBODIMENTS

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of example embodiments. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

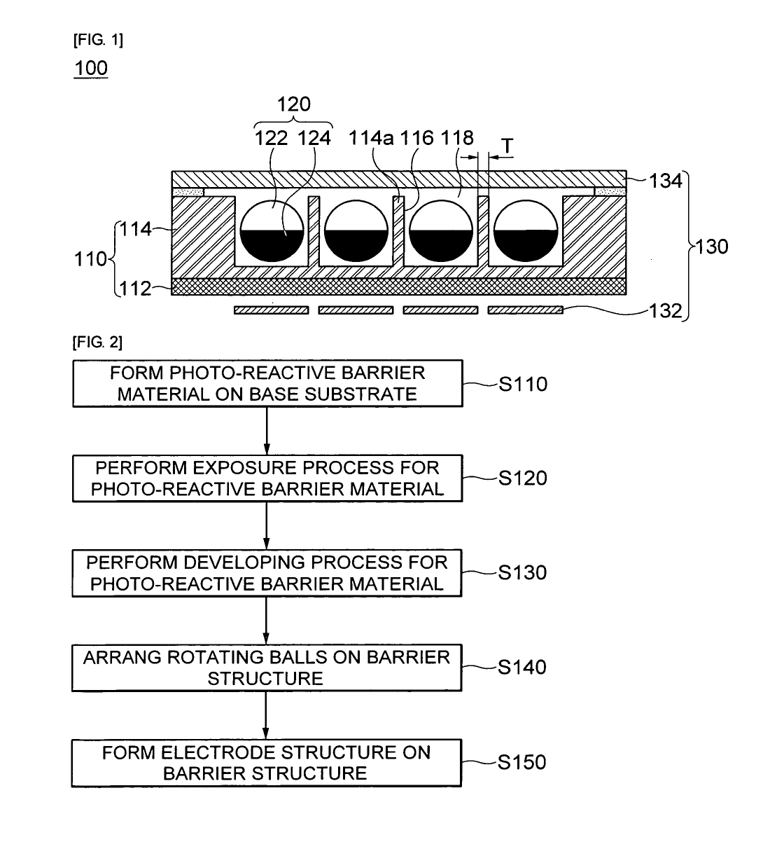

FIG. 1 is a view showing a color electronic paper display device in accordance with an embodiment of the present invention. Referring to FIG. 1, the color electronic paper display device 100 in accordance with an embodiment of the present invention may include a barrier structure 110, rotating balls 120, and an electrode structure 130.

The barrier structure 110 may support and partition the rotating balls 120. The barrier structure 110 may include a base substrate 112 and partition barriers 114 disposed on the base substrate 112. The base substrate 112 may be a supporting substrate for formation and supporting of the partition barriers 114. As for one example, the base substrate 112 may be a plate made of at least one selected from Polyethylene Terephthalate:PET, Polycarbonate:PC, Polyethersulphone:PES, and Polyimide:PI. As other example, the base substrate 112 may be a metal plate made of metallic material like Cu. In case where the base substrate 112 is a metal plate, the base substrate 112 may be used as a lower electrode for driving the rotating balls 120.

The partition barriers 114 may allow each of rotating balls 120 to be partitioned on the base substrate 112. To this end, the partition barriers 114 may have grooves to define cavities 116 where the rotating balls 120 are positioned. Each of the cavities 116 may be filled with insulating transparent oil 118 for providing lubricity to the rotating balls 120 and for providing easy rotation to the rotating balls 120.

The rotating balls 120 may be almost in a sphere shape. Each of the rotating balls 120 may include first and second hemispheres 122 and 124 electrified with different charges from each other. In addition, the first and second hemispheres 122 and 124 may have different colors from each other. As for one example, in case where the color electronic paper display device 100 is a black and white display device, the first hemisphere 122 may be a white hemisphere and the second hemisphere 122 may be a black hemisphere. As for another example, in case where the color electronic paper display device is a color display device, the first hemisphere 122 may correspond to any one of blue, yellow, red, and green hemispheres, and the second hemisphere 124 may correspond to one of block and white hemispheres. The first and second hemispheres 122 and 124 in each of the rotating balls 120 may have different colors in modification and combination modes.

The electrode structure 130 may allow the rotating balls 120 to rotate. For example, the electrode structure 130 may include a lower electrode which is disposed on the lower portion of the barrier structure 110, and an upper electrode 134 which is disposed on the upper portion of the barrier structure 110. By applying voltages selectively to the rotating balls 120, the upper and lower electrodes 132 and 134 allows the rotating balls 120 to be rotated in such a manner that one of the first and second hemispheres 122 and 124 is oriented toward the outside (that is, upper portion of FIG. 1) so as to represent a desired color.

Meanwhile, the partition barriers 114 may be structured so that the number of the rotating balls 120 is increased for each of unit-areas. As for one example, the partition barriers 114 may have side walls 114a with an up and down vertical structure. The side walls 114a may have side surfaces to define shapes of the cavities 116. The side surface surrounds the cavities 116, and thus may have a cylinder shape. In case where the side walls 114a have an up and down vertical side surfaces, in comparison with the side walls whose thicknesses become thicker and thicker as reaching a direction where the base substrate 112 is oriented (down direction of FIG. 1), the number of the rotating balls 120 may be increased according to unit-areas of the base substrate 112.

Also, the thicknesses (T) of the side walls 114a may be minimized. For example, as the side walls 114a become thicker and thicker, it is possible to decrease areas occupied by the side walls 114a of each of unit-areas of the base substrate 112 and to reduce the intervals between the cavities 116 as well. Thus, in case where the thicknesses of the side walls 114a become to be thinnest, it is possible to increase the number of the rotating balls 120 for each of unit-areas. Therefore, it is preferable to adjust the side walls 114a to have minimum thicknesses. For one example, each of the side walls 114a may be adjusted to have a thickness of 20 μm or lower.

Herein, the barrier structure 110 may be formed through a photolithography process. To this end, the barrier structure 110 may be formed of a photo-reactive barrier material. For example, the barrier structure 110 may include insulating resin, hardener, and a photo-sensitive material. The insulating resin may include an epoxy resin based material. For one example, the insulating resin may include at least one of naphthalene-based epoxy resin and rubber modified epoxy resin. The hardener may include at least one of phenol novolac and bisphenol novolac. The photo-sensitive material may include the photo-sensitive monomer and the photo-initiator. The photo-sensitive monomer may be a material having caryboxylic acid:COOH and double combination within a chemical structure. As for the photo-sensitive monomer, acrylate resin may be used.

Also, the photo-reactive barrier material may further include curing accelerator and inorganic filler. Imidazole compound may be used as the curing accelerator. As the inorganic filler, at least one of carbon black, silica, and clay may be used.

As described above, the color electronic paper display device 100 of the present invention has a barrier structure 110 which is provided with the side walls 114a for partitioning the rotating balls 120. The barrier structure 110 may be formed of the photo-reactive barrier material, and may be formed through a photolithography process. In this case, side walls of the barrier structure may define cavities with high aspect ratios and have thin thicknesses, so intervals between the cavities on which the rotating balls are positioned can be reduced. Thus, the color electronic paper display device of the present invention has a structure in which the number of rotating balls is increased for each of unit-areas, so that it is possible to improve color clarity and contrast ratio.

Continuously, a detailed description will be given of a method for manufacturing the color electronic paper display device of the present invention. Herein, the repeated description thereof will be omitted or simplified.

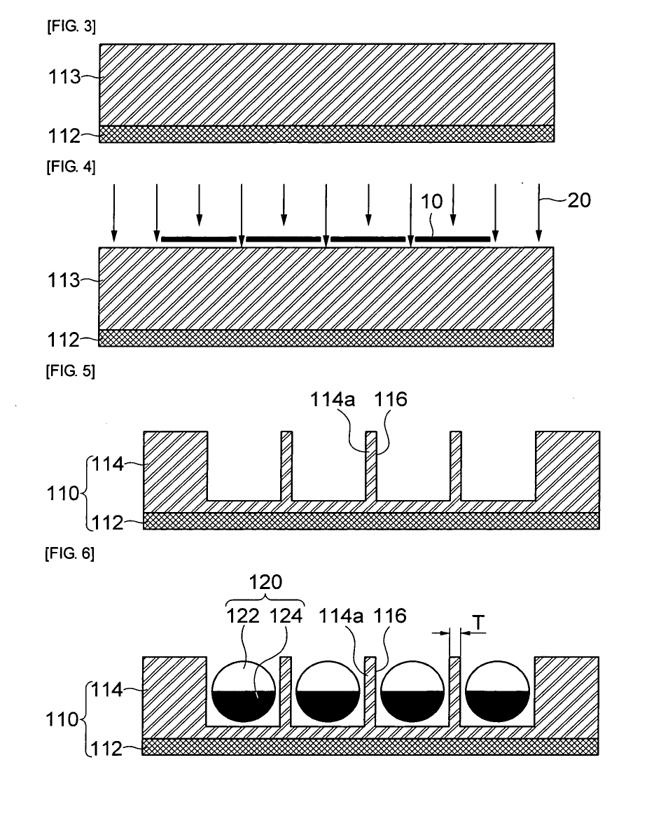

FIG. 2 is a flowchart showing a method for manufacturing the color electronic paper display device in accordance with an embodiment of the present invention. FIGS. 3 to 7 are views showing a process of manufacturing the color electronic paper display device in accordance with an embodiment of the present invention, respectively.

Referring to FIGS. 2 and 3, the photo-reactive barrier material 113 may be formed on the base substrate 112 (step S110). For example, the base substrate 112 may be prepared. The step of preparing the base substrate 112 may include a step of preparing a plate made of at least one selected from Polyethylene Terephthalate:PET, Polycarbonate:PC,

Polyethersulphone:PES, and Polyimide:PI. Also, the step of preparing the base substrate 112 may include a step of preparing a plate made of a metallic material such as Cu.

The photo-reactive barrier material 113 may be formed on the base substrate 112. For example, the photo-reactive barrier material 113 may be prepared. The step of preparing the photo-reactive barrier material 113 may include a step of manufacturing a mixing solution made by mixing insulating resin, hardener, curing accelerator, inorganic filler, and photo-sensitive material. As the insulating resin, at least one of naphthalene based epoxy resin and rubber modified epoxy resin may be used. As for the hardener, at least one of phenol novolac and bisphenol novolac may be used. The photo-sensitive material may include the photo-sensitive monomer and the photo-initiator. As for the photo-sensitive monomer, acrylate may be used. As for the curing accelerator, imidazole compound may be used. As for the inorganic filler, at least one of graphite, carbon black, silica, and clay may be used.

And, the photo-reactive barrier material 113 made of the above-mentioned composition may be formed on the base substrate 112 at a uniform thickness. For example, the photo-reactive barrier material 113 is subjected to a film casting process to thereby be formed on the base substrate 112 in a film type. The thickness of the photo-reactive barrier material 113 formed on the base substrate 112 may be adjusted to be about 50 μm to 120 μm. And, the photo-reactive harrier material 113 formed in the film type is subjected to a laminating process at a predetermined temperature and a predetermined pressure, and then is subjected to a dry process. The pressure applied to the photo-reactive barrier material 113 may range from 0.7 Kgf to 7.5 Kgf, and the temperature may be adjusted at temperatures of about 60° C. to 100° C.

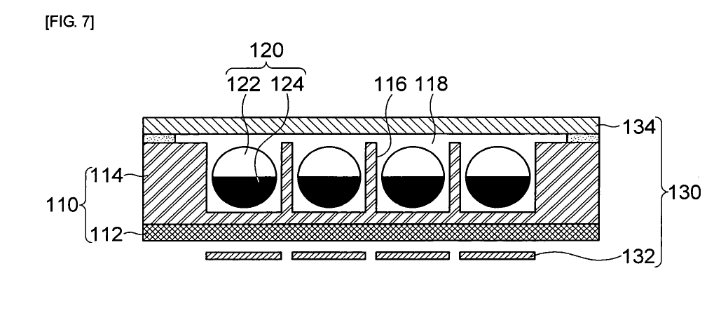

Referring to FIGS. 2 and 4, an exposure process may be performed for the photo-reactive barrier material 113 (step S120). The step of performing the exposure process may include a step of preparing a mask 10, selectively light-shielding desired regions where the cavities (indicated by reference numeral 116 of FIG. 5) are to be formed, on the photo-reactive barrier material 113, and a step of scanning light 20 on the photo-reactive barrier material 113 through the mask 10.

Meanwhile, after the exposure process, a first heat-treatment process for curing the photo-reactive barrier material 113 may be further performed. In the first heat-treatment process, a pre-cure process may be performed for the photo-reactive barrier material 113 to thereby perform heat-curing a part of the photo-reactive barrier material 113.

Referring to FIGS. 2 and 5, a developing process may be performed for the photo-reactive barrier material 113 (step S130). For example, the step of performing the developing process may include a step of supplying a developing solution and organic solvent to the photo-reactive barrier material 113 which have been subjected to an exposure process described with reference to FIG. 4. In the step of developing the photo-reactive barrier material 113 by the organic solvent, a step of applying ultrasound to the photo-reactive barrier material 113 may be additionally performed. As for the developing solution, a developing solution containing Na₂CO3 may be used. As for the organic solvent, thing to dissolve insulating resin within the photo-reactive barrier material 113 may be used. As for one example of the organic solvent, 2-methoxy ethanol may be used.

After the developing process, a second heat-treatment process for curing the photo-reactive barrier material 113 may be further performed. In the second heat-treatment process, the photo-reactive barrier material 113 may be cured at temperature of about 150° C. or higher.

By the above-mentioned developing process, non light-receiving areas of the photo-reactive barrier material 113 may be removed. Thus, it is possible to manufacture the barrier structure 110 which is provided with the base substrate 112 and the partition barriers 114 for partitioning the cavities 116 on the base substrate 112. Herein, the partition barriers 114 may have side walls 114a for defining the cavities 116. The side walls 114a are formed by being subjected to the photolithography process, and may have a structure with a high aspect ratio. Thus, each of the partition barriers 114 may have up and down vertical side surfaces and a circle-shaped cross section. Also, the thicknesses (T) of the side walls 114 may be adjusted to be within 20 μm By the side walls 114a with the above-mentioned structure, each of the cavities 116 may have a cylindrical shape. That is, each of the cavities 116 may have upper and lower openings with the same diameter as each other.

Referring to FIGS. 2 and 6, the rotating balls 120 may be disposed on the barrier structure 110 (step S140). For example, the rotating balls 120 are allowed to be self-aligned on each of the cavities 116 of the barrier structure 110, so that it is possible to dispose the rotating balls 120 on the same plane of the base substrate 112. Herein, as the thicknesses (T) of the side walls 114a of the barrier structure 110 become relatively thin, the number of the rotating balls 120 disposed on each of unit-areas of the base substrate 112 may be increased.

Referring to FIGS. 2 and 7, the electrode structure 130 may be formed on the barrier structure 110 (step S150). The step of forming the provisional dryer 130 may include a step of disposing an lower electrode 132 on a lower portion of the barrier structure 110, and a step of disposing an upper electrode 134 on an upper portion of the barrier structure 110.

Also, a step of injecting transparent oil 118 into the cavities 116 may be additionally performed. The transparent oil 118 may be injected into the cavities 116 through an inlet (not shown) provided between the barrier structure 110 and the upper electrode 134.

As described above, according to a method for manufacturing the color electronic paper display device of the present invention, a photo-reactive barrier material is prepared and the prepared photo-reactive barrier material is subjected to a photolithography process, so that it is possible to form the barrier structure for partition the rotating balls. In this case, the barrier structure for partitioning the rotating balls may be manufactured to have side walls of high aspect ratios and thin thicknesses. Thus, in a method for manufacturing the color electronic paper display device of the present invention, it is possible to manufacture the color electronic paper display device with a structure where the number of rotating balls is increased for each of unit-areas to thereby improve color clarity and contrast ratio.

According to the present invention, the color electronic paper display device includes barrier structure with side walls. The barrier structure may be formed of a photo-reactive barrier material, so it may be formed by a photolithography process. In this case, the side walls of the barrier structure define cavities with high aspect ratios and have thin thicknesses, so that it is possible to increase the number of the rotating balls for each of unit-areas. Thus, the color electronic paper display device has a structure to increase the number of the rotating balls for each of unit-areas, so that it is possible to improve color clarity and contrast ratio.

In a method for manufacturing the color electronic paper display device of the present invention, the photo-reactive barrier material is prepared, the prepared photo-reactive barrier material is subjected to a photolithography process, so that it is possible to form a barrier structure to partition the rotating balls. In this case, side walls of the barrier structure which partitions the rotating balls may be manufacture to have high aspect ratios and thin thicknesses. Thus, in the method for manufacturing the color electronic paper display device, it is possible to provide a structure to implement an increase in the number of the rotating balls for each of unit-areas, so that it is possible to manufacture the color electronic paper display with high color clarity and contrast ratio.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

1. A color electronic paper display device comprising:
rotating balls;
a barrier structure for partitioning the rotating balls; and
an electrode structure which is provided in the barrier structure and applies voltages to the rotating balls,
wherein the barrier structure is made of a photo-reactive barrier material including insulating resin, hardener, and a photo-sensitive material.

2. The color electronic paper display device of claim 1, wherein the insulating resin includes at least one of naphthalene epoxy resin and rubber modified epoxy resin.

3. The color electronic paper display device of claim 1, wherein the hardener includes at least one of phenol novolac and bisphenol novolac.

4. The color electronic paper display device of claim 1, wherein the photo-sensitive material includes a photo-sensitive monomer and photo-initiator, the photo-sensitive monomer including acrylate resin.

5. The color electronic paper display device of claim 1, wherein the photo-reactive barrier material further includes an inorganic filler, the inorganic filler including at least one of graphite, carbon black, silica, and clay.

6. The color electronic paper display device of claim 1, wherein the barrier structure includes side walls for partitioning each of the rotating balls, the side walls defining cavities with cylinder shapes.

7. The color electronic paper display device of claim 1, wherein the barrier structure includes side walls for partitioning each of the rotating balls, the side walls defining the cavities whose upper and lower diameters are the same.

8. The color electronic paper display device of claim 1, wherein the barrier structure includes side walls for partitioning each of the rotating balls, the side walls having side surfaces with an up and down vertical structure.

9. The color electronic paper display device of claim 1, wherein the barrier structure includes side walls for partitioning each of the rotating balls, the side walls having thicknesses of 20 μm or lower.

10. The color electronic paper display device of claim 1, wherein the barrier structure is formed through a photolithography process.

11. A method for manufacturing a color electronic paper display device comprising:
preparing a photo-reactive barrier material which includes an insulating resin, hardener, and a photo-sensitive material;
forming a barrier structure for defining cavities of cylinder shapes, on a base substrate;
positioning rotating balls within the cavities; and
forming an electrode structure which applies voltages to the rotating balls on the barrier structure.

12. The method of claim 11, wherein at least one of naphthalene epoxy resin and rubber modified epoxy resin is used as the insulating resin.

13. The method of claim 11, wherein at least one of phenol novolac and bisphenol novolac is used as the hardener.

14. The method of claim 11, wherein the photo-sensitive material includes a photo-sensitive monomer and a photo-initiator, the photo-sensitive monomer including acrylate resin.

15. The method of claim 11, wherein forming the barrier structure further comprises curing the photo-reactive barrier material.

16. The method of claim 11, wherein forming the barrier structure comprises:
forming the photo-reactive barrier material on the base substrate at a uniform thickness; and
performing a photolithography process for the photo-reactive barrier material.

17. The method of claim 16, wherein performing the photolithography process comprises:
positioning a mask for light-shielding desired regions where the cavities of the photo-reactive barrier material are to be formed;
scanning light on the photo-reactive barrier material through the mask; and
performing a developing process for removing non light-receiving areas of the photo-reactive barrier material.

18. The method of claim 17, wherein performing the developing process comprises:
supplying a developing solution containing Na₂CO₃ to the photo-reactive barrier material; and
supplying an organic solvent to dissolve the insulating resin of the photo-reactive barrier material.
